(19) United States
(12) Patent Application Publication
(10) Pub. No.: US 2012/0247373 A1
(43) Pub. Date: Oct. 4, 2012

(54) Protection and Tracking System for Valuables

(75) Inventor: Sonny Van Dessel, Haacht (BE)

(73) Assignee: 3SI Security Systems N.V., Zaventem (BE)

(21) Appl. No.: 13/514,506

(22) PCT Filed: Dec. 8, 2010
(86) PCT No.: PCT/EP2010/069164

§ 371 Date: Jun. 7, 2012

(30) Foreign Application Priority Data
Dec. 8, 2009 (EP) 09178334.0

(51) Int. Cl. E05G 1/14; E05G 1/02; G07F 19/00; E05G 1/12

(52) U.S. Cl. 109/31; 109/32

(57) ABSTRACT

The invention relates to a protection unit for use in or as a secured container, comprising a compartment for storage of valuables, a detection unit, a track and trace unit, and a foam generating unit comprising a quick expanding and hardening or sticky foam, wherein detection by the detection unit of an unallowed event triggers the track and trace unit and the foam generating unit for trapping the operational track and trace unit and valuables into a block of foam. The electronics for track and tracing may comprise a module for transmission via telecommunication or internet of its position to a remote receiver.

### CROSS REFERENCE TO RELATED APPLICATIONS

This application is the national phase filing of international patent application No. PCT/EP2010/069164, filed 8 Dec. 2010, and claims priority of European patent application number 09178334.0, filed 8 Dec. 2009, the entireties of which applications are incorporated herein by reference.

### FIELD OF THE INVENTION

The present application concerns a track and trace application for protecting valuables inside a safe or other secured container for valuables during robbery or unauthorized opening of the safe or secured container.

### BACKGROUND OF THE INVENTION

It is known to use a device whereby smoke and/or tear gas is released inside the safe or secured container upon certain movements of said safe or secured container, such as tilting, rotation, translation or any combination thereof, or when specific drilling, grinding, hammering or other patterns are detected. The smoke colours the valuables and makes them useless. This is known from numerous patents/patent applications; see for example EP 0693902, EP 0914538, WO 92/07159.

In spite of the colouring of the valuables, many times the valuables are never retrieved and remain lost values for the owner.

There is therefore a need for retrieving the valuables. This may be achieved by a track and trace unit connected with the stolen items that informs the owner and/or the police as to where the valuables may be found.

As a result, the valuables can be retrieved, and other valuable information can be collected, such as the location of the robbers or a place they use for storage or other activities, thus increasing the chances of possible arrests.

However, the track and trace unit is often detected and removed by the robbers.

### SUMMARY OF THE INVENTION

The aim of the present invention therefore is to improve the secured container by increasing the difficulty for the robbers to separate the track and trace unit from the stolen items.

According to one aspect of the invention, this aim can be achieved by means of a protection unit positioned inside the secured container, such as a safe, a so-called CIT container (cash-in-transit), a ATM cassette or ATM (automatic teller machine). The valuables may be stored inside this protection unit, together with a detection unit, a trace and track unit and a foam generating unit comprising a quick expanding foam, such as polyurethane foam or other foam which polymerizes or cross-links into a hard, tough and/or sticky mass, the detection by the detection unit of an event triggering the track and trace unit and the foam generating unit, thus trapping the operational track and trace unit and valuables into a block of hard, tough and/or sticky foam.

As of the moment an attack on the safe is detected by the “Protection Unit” inside the safe, the track and tracing will be initiated. Detection and activation may be achieved by various known means, including electronic means and sensors not part of the invention but known in the art and selected as appropriate for the relevant uses and applications. The detection unit may be a detection unit known in the art that allows for detection of certain manipulations or movements, like tilting, rotation, translation, shaking or others, or certain unauthorized actions, like hammering, drilling and/or sawing or others, and to trigger the track and trace unit and/or the foam spraying by the foam generating unit.

According to a preferred embodiment, the track and trace unit comprises a GPS/GPRS/RF system or other positioning system and possibly a secured web-based solution. This arrangement of a track and trace unit connected to the valuables by way of a hardened and/or sticky foam will allow the owner and/or the police to locate the stolen items and possibly the robber(s).

In parallel with the start of the tracking, the foam may be released thus preferably filling up the substantially complete inside volume, including the storage area of the valuables and the location of the track and trace unit, preferably also including the battery for prolonged operation. During foam expansion and after the drying and hardening period, the valuables and the track and trace unit are caught in a hard cocoon and/or sticky mass and thus kept together.

The foam may consist in a one or two component polyurethane foam, released from pressurized cans or containers as a one or two component foam precursor, respectively.

In principle, it is possible to access the valuables and/or the track and trace unit, for instance by cutting them out of the hardened foam, but it will take time for anybody to do that. This causes additional delay which may advantageously be used by the owner and/or the police to locate the stolen items and/or the robbers, to retrieve the valuables and possibly to make arrests. In any case, such additional hurdle discourages robbers to even take action.

The protection unit according to the invention may advantageously comprise a ink dye or smoke release unit. Same may be operated such as to release the ink dye and/or smoke in such a way as to affect the valuables, e.g. paper money, before the foam traps them into a hardened possibly sticky foam block.

Advantageously, a nucleic acid marker may be mixed into or linked to the foam precursor or may be released separately. The aim, of course, is to allow later allocation of retrieved valuables.

According to an alternative embodiment, suitable for transport of secret information stored on a digital data carrier, the protection unit may include a destruction module, such as high electrical and/or magnetic field generators or microwave generator that destroys the digital information stored in the data carrier.

According to the invention, the “Protection unit” advantageously is a cage that may be lodged or fixed inside a regular safe. The foam may then fill-up substantially the complete area inside the cage during its expansion and after the drying and hardening period, the valuables and the track and trace unit then are caught in a hard cocoon and/or sticky mass and thus kept together.

According to a preferred embodiment the protection unit may be covered by a detection film or skin known in the art intended to trigger the foam generating unit and the track and trace unit. Unauthorized opening of the preferred embodiment may also trigger the foam generating unit and the track and trace unit.

According to another embodiment, the cage may be arranged inside a so-called CIT (cash-in-transit)container. Unauthorized manipulation or unauthorized opening or possibly remote control may initiate the foam generating unit which may release a quickly hardening foam in the valuable storage area as well as the track and trace unit.

Both, the track and trace unit and the valuables are then embedded into a block of hardened foam or sticky mass. The separation of valuables from the track and trace unit will delay the robbers and may possibly lead to their arrest.

According to yet another embodiment, the cage may be arranged inside or consist in an ATM (automatic teller machine) cassette. Such cassettes are used to store, collect and distribute money in an ATM and are transported, containing money, from cash centers to ATMs and vice versa. As mentioned above, unauthorized use or unauthorized opening or remote control may trigger the track and trace system and the foam generating system.

Automatic teller machines are more and more the object of burglary. They are sometimes pulled out of their seat by heavy weight equipment. The protection unit of the invention may thus alternatively be arranged inside an automatic teller machine and be triggered by unauthorized manipulation of same.

### BRIEF DESCRIPTION OF DRAWINGS

The invention will be described in more details herein below with reference to drawings:

FIG. 1 discloses an embodiment of a protection unit according to the invention, intended for use in a safe;

FIG. 2 is a schematic representation of the cage of FIG. 1 showing the essential elements of the invention cage; and

FIG. 3 shows an exploded view of an ATM cassette according to the invention.

### DETAILED DESCRIPTION OF THE INVENTION

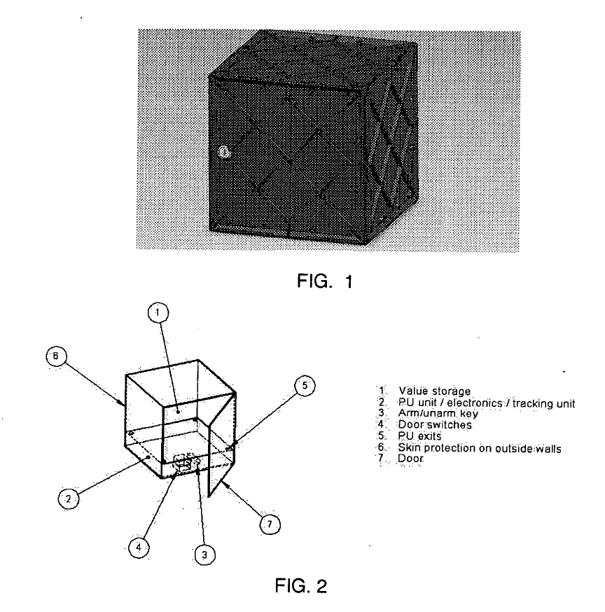

According to the embodiment of FIG. 1, the entire “Protection Unit” may comprise a box with well-defined dimensions. Inside the box, the valuable storage area 1 can be completely open or divided by one or two shelves to place the valuables such as bank notes or jewelry. This is the area that will be filled-up with fast hardening foam, for example polyurethane, if a robbery is detected.

The door may be opened by means of a physical key 3. One may obviously also provide for electronic locks or electronic data keys or similar means. This key locks the door 7 and arms the “Protection Unit”. Unlocking the door 7 will disarm the “Protection Unit”.

The opening and closing of the door 7 may be detected by a door switch or sensor 4. Opening the door without disarming the unit may create an immediate activation of the track and trace unit and the foam generating unit 2 releasing preferably polyurethane foam through exits 5.

All surfaces from the “Protection Unit” may be protected by means of a protection skin 6. Creating openings in this protection skin 6 allowing access to the valuables may be detected by such skin 6 and result in an immediate activation of the track and trace unit and the spraying of a foam, such as a one component polyurethane foam 2, by the foam generating unit.

The polyurethane is released in the valuable storage area 1 through the PU exit 5.

In the alternative, a sticky expanded mass may be used to fill up the inner volume of the secured container. Such sticky mass may further be used to expand through ports practiced in the external walls of the secured container and thus stick same onto or into its support or casing, as the case may be, or have it adhere to the robbers' hands or clothing.

The electronics 2 may be equipped with a processor containing all logical functioning and a motion sensor to detect tilting or other movements of the safe. The processor may include a logs event history and log the events that happen with the “Protection Unit”. An event has to be understood as a status change of the unit or any sensor status change. Each event may be logged together with a time stamp containing date and time.

A battery is preferably part of the electronics and takes care of the autonomous working of the “Protection Unit”. Obviously, the protection unit and/or the container containing it may be equipped with a communication port. Such communication port may be used to charge the battery, either by a direct wired connection or by means of an unwired connection, such as via Radio frequency.

LED indication on the outside of the “Protection unit” may take care of the visual communication towards the user. A buzzer integrated in the electronics 2 may take care of the acoustic communication towards the user.

The “Protection unit” may be adapted to use the track and trace unit also in combination with ink dye technology or in combination with smoke dye technology or possibly nucleic acid markers.

The hardened foam may in fact envelop and engulf not only the valuables but the entire content of the inside cage, possibly including the battery, electronics and telecommunication means so that these means will be trapped, while still operating, and difficultly accessible to the robbers after activation of the security system. The delay in separating the valuables from the track and trace unit is intended to discourage the robbers from taking the valuables or even attacking such secured containers. The electronics may optionally be coated or cast in a polymeric resin, such as an epoxy-resin, thus protecting the circuitry from undesirable effects due to the foam expansion.

Secured containers as described above or similar thereto may be placed into so-called CIT containers for transport of valuables. One may thus also equip such CIT containers with a foam generating unit and a track and trace unit, such that both are locked into a foam block when misused or when the CIT container is unlocked in an authorized fashion.

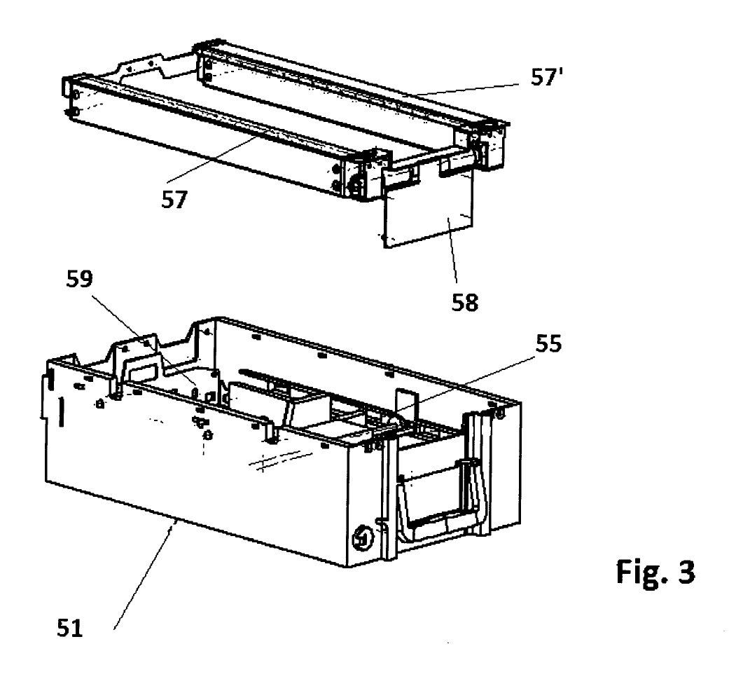

According to another embodiment of the invention shown in FIG. 3, the protection unit may consist in an automatic teller machine cassette 51 known in the art. The inside of said cassette comprises several compartments, one of which may be equipped with a track and trace unit 55, another one with a foam generating unit 57 and/or 57′, a detection unit 58 and another one with the valuables 59. Unauthorized manipulation, tampering or unallowed unlocking of the cassette is detected by the detection unit 58 which triggers the spraying of a quick hardening foam within the cassette, thus embedding and trapping at least the valuables and the track and trace unit into a block of foam, preferably polyurethane foam. In addition, one may also provide for that the safety system is initiated even if the cassette is located for use in an automatic teller machine and said machine is the object of robbery or burglary, for instance by means of heavy weight equipment intended to pull it out of its seat. In the alternative or additionally, the machine body may constitute the secured container equipped with detection unit, track and trace unit and foam generating unit initiated by unauthorized manipulation or tampering, whereby the released foam locks valuables, e.g. the ATM cassettes, and track and trace unit in a block of hardened foam.

1. A protection unit comprising a compartment for storage of valuables, a detection unit, a track and trace unit and a foam generating unit comprising a quick expanding foam, the unit configured for detection by the detection unit of an unallowed event to trigger the track and trace unit and the foam generating unit and to thus trap the operational track and trace unit and valuables within a block of foam.

2. The protection unit of claim 1, wherein the storage compartment has an inside volume and the foam generating unit and foam are selected in order to substantially fill the entire inside volume of the compartment with foam when triggered.

3. The protection unit of claim wherein the foam is a single component polyurethane foam.

4. The protection unit of claim 3, wherein the foam is delivered from a pressurized can or container as a one component polyurethane foam precursor.

5. The protection unit of claim 1 wherein the foam is delivered from pressurized cans or containers as two component polyurethane foam precursors.

6. The protection unit of claim 1, wherein the track and trace unit comprises a positioning system selected from the group consisting of GPS, GPRS, RF means positioning systems or a combination thereof.

7. The protection unit of claim 1, wherein at least the track and trace unit is connected to a battery arrangement configured to be trapped in the foam released from the foam generating unit.

8. The protection unit of claim 1 further comprising an ink dye or smoke release unit.

9. The protection unit of claim 1, further comprising a nucleic acid marker release unit.

10. The protection unit of claim 1, wherein at least one nucleic acid marker is mixed into or linked to the foam.

11. The protection unit of claim 1, further comprising a destruction module.

12. A safe comprising the protection unit of claim 1.

13. The safe of claim 12, wherein the protection unit is enveloped by a skin sensitive to intrusion, wherein the skin comprises the detection unit and the unallowed event for triggering the track and trace unit and the foam generating unit comprises a detection of intrusion sensed by the skin.

14. The safe of claim 12 wherein the protection unit is configured to allow the foam released from the foam generating unit to substantially fill the entire inside volume of the safe.

15. The safe of claim 12 wherein the protection unit comprises a door with switches and a physical key for locking the door and arming the detection means.

16. A secured transport container comprising the protection unit of claim 1.

17. An automatic teller machine cassette comprising the protection unit of claim 1.

18. An automatic teller machine comprising the protection unit of claim 1.

19. The protection unit of claim 6 further comprising a secured web-based communication module.

20. The protection unit of claim 1, wherein the protection unit is enveloped by a protective skin adapted to sense creation of an opening in the skin, in which the unallowed event for triggering the track and trace unit and the foam generating unit comprises detection of an opening in the skin.

21. The protection unit of claim 1, wherein the protection unit comprises a cage configured for placement inside a secured container.

22. The protection unit of claim 1, wherein the secured container is selected from the group consisting of: a safe, a cash-in-transit container, an automatic teller machine, and an automatic teller machine cassette.

23. A secured container comprising a compartment for storage of valuables, a detection unit, a track and trace unit, and a foam generating unit comprising a quick expanding foam, the detection unit configured such that detection of an unallowed event triggers the track and trace unit and the foam generating unit to trap the operational track and trace unit and valuables within a block of foam.

24. The secured container of claim 23, wherein the storage compartment has an inside volume and the foam generating unit and foam are selected in order to substantially fill the entire inside volume of the compartment with foam when triggered.
